(19) United States
(12) Patent Application Publication
(10) Pub. No.: US 2006/0086712 A1
(43) Pub. Date: Apr. 27, 2006

(54) Safety device for flat irons based on optical motion detection

(76) Inventor: David C. Feldmeier, Sunnyvale, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/973,571

(22) Filed: Oct. 25, 2004

(51) Int. Cl. D06F 75/26; H05B 1/02

(52) U.S. Cl. 219/250

(57) ABSTRACT

A method for operating an appliance includes (1) turning on the appliance, (2) determining if the appliance is moving with sufficient velocity with an optical motion sensor, and (3) if the appliance is not moving with sufficient velocity, turning off the appliance. An appliance includes an optical motion sensor for detecting motion of the appliance and a controller coupled to the optical motion sensor, wherein the controller turns off the appliance if the appliance is not moving with sufficient velocity.

### DESCRIPTION OF RELATED ART

A flat iron is a useful home appliance for pressing wrinkled fabrics. However, a problem occurs if a hot flat iron is left resting on a piece of fabric. The fabric may be damaged or even set on fire. A piece of fabric that catches fire represents a danger to both people and property.

One existing solution is to use a timer. To use the iron, the timer must be set. When the timer expires, the iron shuts off until the timer is set again. A disadvantage of this solution is that a short timeout period provides increasing safety but it is also inconvenient because the timer must be reset often. If a long timeout period is used, the iron may rest on a piece of fabric for a long time before shutting off and therefore cause damage to the fabric or even a fire.

Another existing solution is to use a motion sensor. However, a single motion sensor in an iron cannot determine both the motion of the iron and the orientation of the iron (e.g., determining if the iron is sitting flat against a surface or on its heel and away from the surface). Thus, both a motion sensor and a tilt sensor would have to be used, thereby increasing the cost of the iron. Some motion sensors also use a mercury tilt switch, which is difficult to dispose after the useful life of the iron.

Yet another existing solution is an iron that uses only steam. As the temperature of steam is below the ignition temperature of most fabrics, such an iron will not cause fabric to catch fire even if it is left in contact with the fabric for an extended period of time. A disadvantage of this solution is that a steam-only iron does not remove wrinkles as well as a conventional flat iron.

Thus, what is needed is an iron that addresses the above-described disadvantages.

### SUMMARY

In one embodiment of the invention, a method for operating an appliance includes (1) turning on the appliance, (2) determining if the appliance is moving with sufficient velocity with an optical motion sensor, and (3) if the appliance is not moving with sufficient velocity, turning off the appliance.

In one embodiment of the invention, an appliance includes an optical motion sensor for detecting motion of the appliance and a controller coupled to the optical motion sensor, wherein the controller turns off the appliance if the appliance is not moving with sufficient velocity.

### BRIEF DESCRIPTION OF THE DRAWINGS

FIG. 1 illustrates a schematic of an electric flat-iron in one embodiment of the invention.

FIG. 2 illustrates a schematic of an optical sensor for the iron of FIG. 1 in one embodiment of the invention.

FIG. 3 is a flowchart of a method to operate the iron of FIG. 1 in one embodiment of the invention.

FIG. 4 is a flowchart of a method to operate the iron of FIG. 1 in another embodiment of the invention.

FIG. 5 illustrates a schematic of another optical sensor for the iron of FIG. 1 in another embodiment of the invention.

Use of the same reference numbers in different figures indicates similar or identical elements.

### DETAILED DESCRIPTION

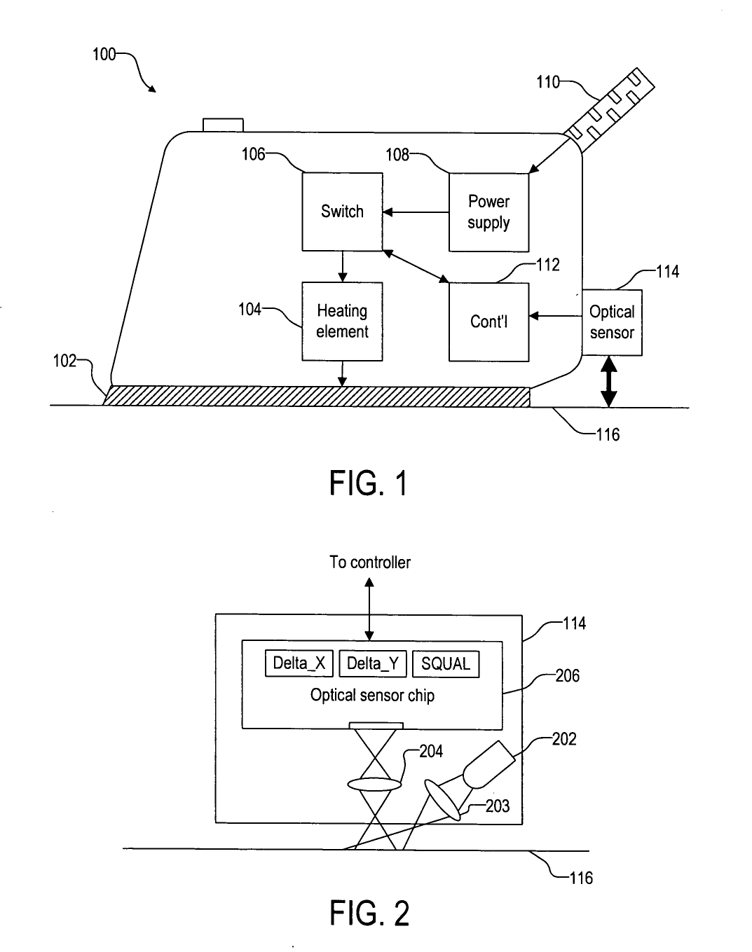

FIG. 1 illustrates an electric flat iron 100 in embodiment of the invention. Iron 100 has a heated sole plate 102 that is pressed against fabric to remove wrinkles. Sole plate 102 has an electrical resistance heating element 104. Heating element 104 is coupled by a power switch 106 to a power supply 108. Power supply 108 in turn coupled to a power cord 110.

A microcontroller 112 is coupled to an optical motion sensor 114 mounted on the heel of iron 100. Sensor 114 may be mounted away from sole plate 102 to avoid heat damage. Sensor 114 is able to detect the motion of iron 100 over a working surface 116 as well as the orientation of iron 100 (e.g., flat against or lifted away from surface 116). Sensor 114 is also ore sensitive to motion than conventional motion sensors used in irons. Depending on the motion of iron 100, microcontroller 112 closes or opens switch 106 to turn on or off heating element 104.

FIG. 2 illustrates one implementation of optical motion sensor 114 in one embodiment of the invention. In one embodiment, sensor 114 is an optical navigation sensor for optical mouse available from Agilent Technologies, Inc. of Palo Alto, Calif.

Sensor 114 includes a light source 202 (e.g., a light emitting diode) that illuminates surface 116. Light source 202 may generate a light that is not visible, such as infrared and ultraviolet. A lens 203 directs the light from light source 202 onto an area on surface 116. The light reflects off microscopic textural features in the area. A lens 204 collects the reflected light and forms an image on an optical sensor chip 206.

Light source 202 can also be an indicator of the state of iron 100 to the user. For example, light source 202 can generate a continuous light when iron 100 is against surface 116 and moving (during use), a fast flashing light when iron 100 is against surface 116 but not moving (during nonuse), and a slow flashing light when iron 100 is not against surface 116 (during liftoff).

Sensor chip 206 captures surface images sequentially and uses common features in these image to determine the movement of iron 100. Sensor chip 206 writes the X and Y displacements over surface 116 in registers Delta_X and Delta_Y, respectively.

Sensor chip 206 also tracks the number of visible features in the surface images in order to detect liftoff of iron 100 from surface 116. A high number of visible features indicates that iron 100 is flat against surface 116 so that sensor chip 206 is receiving in-focus images. On the other hand, a low number of visible features indicates the iron is lifted away from surface 116 so that sensor chip 206 is receiving out-of-focus images. Sensor chip 206 writes the number of visible features in a register SQUAL (Surface QUALity).

Microcontroller 112 is coupled to sensor 114 to read the values in registers Delta_X, Delta_Y, and SQUAL. Note that when light source is also used as an indicator, microcontroller 112 should only read the values in these registers when the light is on because the values are invalid when the light is off.

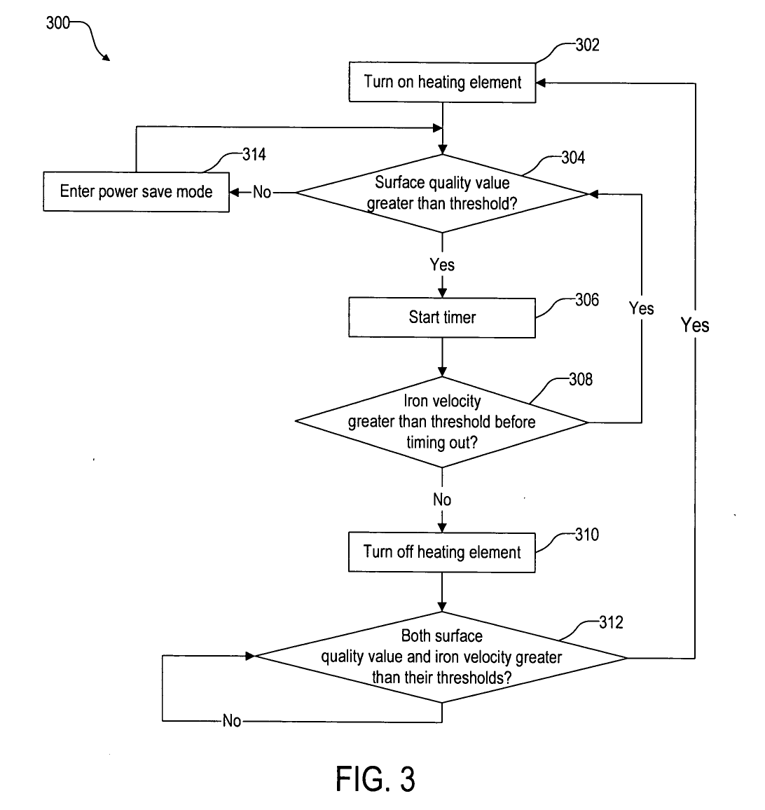

FIG. 3 illustrates a flowchart of a method 300 for operating an appliance, such as iron 100, in one embodiment of the invention.

In step 302, iron 100 is turned on by a user. In response, microcontroller 112 closes switch 106 to turn on heating element 104. Heating element then brings sole plate 102 up to a working temperature for removing wrinkles from fabric. Step 302 is followed by step 304.

In step 304, microcontroller 112 determines if iron 100 is flat against surface 116. Specifically, microcontroller 112 reads the surface quality value from register SQUAL in sensor chip 206. Microcontroller 112 determines if the surface quality value is greater than a threshold value that indicates iron 100 is flat against surface 116. If so, then step 304 is followed by step 306. If the surface quality value is less than or equal to the threshold value, then step 304 is followed by step 314.

In step 306, microcontroller 112 starts a timer. This timer tracks a time period deemed safe for iron 100 to be motionless and flat against surface 116. Step 306 is followed by step 308.

In step 308, microcontroller 112 determines if iron 100 is moving with a velocity sufficient to prevent fabric damage and/or fire hazard prior to timing out. Specifically, microcontroller 112 continuously reads the displacement values from registers Delta_X and Delta_Y in sensor chip 206. Microcontroller then determines the velocity of iron 100 from the displacement values. If the velocity of iron 100 is greater than a threshold value prior to timing out, then step 308 is followed by step 304 and repeats the above-described steps. If the velocity of iron 100 not greater than the threshold value prior to timing out, then step 308 is followed by step 310.

In step 310, microcontroller 112 opens switch 106 to turn off heating element 104 in order to prevent fabric damage and/or fire hazard. Step 310 is followed by step 312.

In step 312, microcontroller 112 determines if iron 100 is flat against surface 116 and moving with sufficient velocity. Specifically, microcontroller 112 determines if the surface quality value from register SQUAL is greater than its threshold, and determines if the displacement values from registers Delta_X and Delta_Y result in a velocity greater than its threshold. If iron 100 is flat against surface 116 and moving with sufficient velocity, then step 312 is followed by step 302 where microcontroller 112 turns on heating element 104 and the above-described steps are repeated. Otherwise step 312 loops until iron 100 is flat against surface 116 and moving with sufficient velocity or the user turns off iron 100 completely.

In step 314, microcontroller 112 puts iron 100 into a power saving mode. In the power saving mode, heating element 104 operates at a lower temperature. This allows iron 100 to return to the working temperature more quickly when it is used again (e.g., flat against surface 116). Iron 100 exits the power saving mode and brings iron 100 back to the working temperature when microcontroller 112 detects that iron 100 is again flat against surface 116. At this point, step 314 is followed by step 304 and the above-described steps are repeated. If microcontroller 112 does not detect that iron 100 is flat against surface 116 with in a period of time, microcontroller 112 can also completely turn off heating element 104.

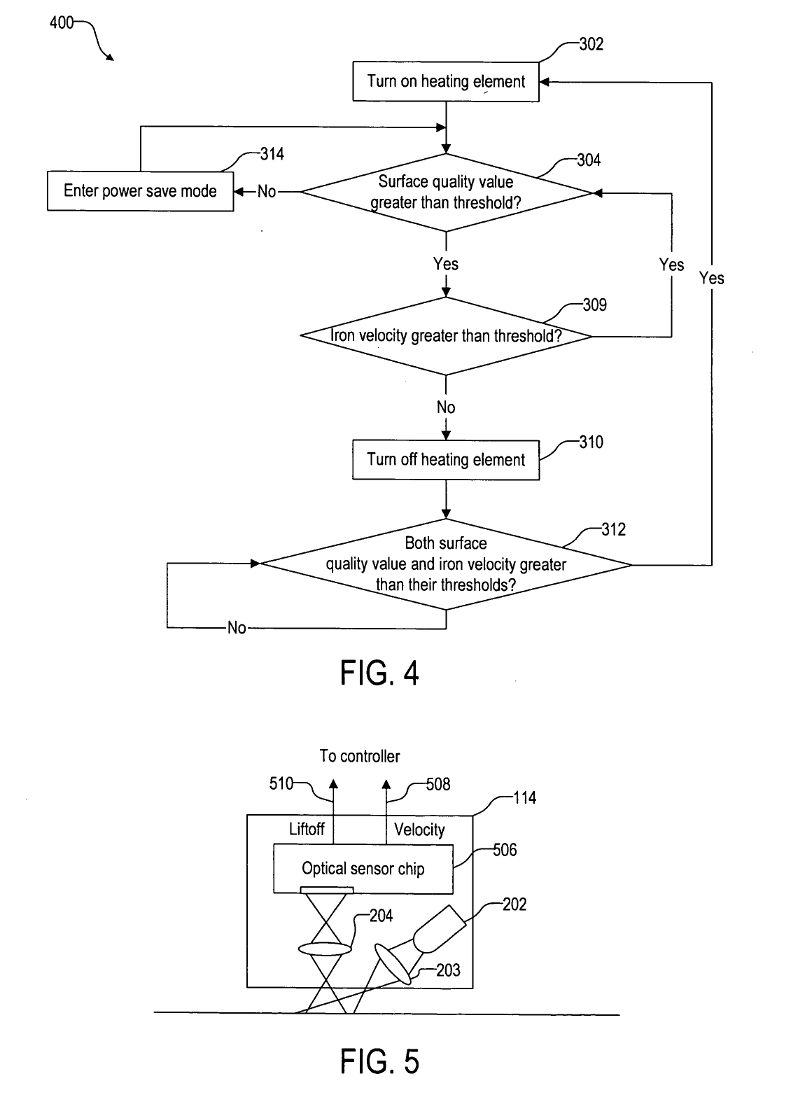

FIG. 4 illustrates a flowchart of a method 400 for operating iron 100 in one embodiment of the invention. Method 400 is similar to method 300 except that steps 306 and 308 are deleted and step 309 is added. In method 400, microcontroller 112 turns off heating element 104 whenever iron 100 is not moving with sufficient velocity. Method 400 relies on the thermal inertia of heating element 104 and sole plate 102 to smooth out minor variations in temperature.

Specifically, step 309 follows step 304 if iron 100 is flat against surface 116. In step 309, microcontroller 112 determines if iron 100 is moving with sufficient velocity. If so, step 309 is followed by step 304. If iron 100 is not moving with sufficient velocity, then step 309 is followed by step 310.

FIG. 5 illustrates another implementation of optical motion sensor 114 in another embodiment of the invention. Instead of having registers where the displacement and liftoff values are stored, optical sensor chip 506 has a velocity signal line 508 and a liftoff signal line 510. When iron 100 is moving with velocity greater than the velocity threshold value, sensor chip 506 puts one logical state (e.g., a logic “1”) on velocity signal line 508, and vice versa. When iron 100 is flat against surface 116 (i.e., when the surface quality value is greater than the liftoff threshold value), sensor chip 506 puts one logic state (e.g., a logic “1”) on liftoff signal line 510, and vice versa.

This implementation of sensor 114 would use an internal circuitry, such as a digital signal processor, to determine the velocity of iron 100 from the displacement values and whether the velocity and liftoff conditions are met. When using this implementation of sensor 114 in method 300 or 400, microcontroller 112 would simply read the logic states on displacement signal line 508 and liftoff signal line 510 instead of a register in the sensor.

Various other adaptations and combinations of features of the embodiments disclosed are within the scope of the invention. For example, the concepts described can be applied to other appliances. Numerous embodiments are encompassed by the following claims.

1-8. (canceled)

9. A method for operating an appliance, comprising:
(1) turning on the appliance;
(2) determining if the appliance is in an operating orientation, wherein said determining if the appliance is in an operating orientation comprises reading a surface quality value from a register in an optical motion sensor, the surface quality value represents a number of visible features in an image captured by the optical motion sensor, the appliance is in the operating orientation when the surface quality value is greater than a threshold;
(3) if the appliance is in the orating orientation:
(a) determining if the appliance is moving with sufficient velocity with the optical motion sensor; and
(b) if the appliance is not moving with sufficient velocity, turning off the appliance.

10-18. (canceled)

19. An appliannce, comprising:
an optical motion sensor for detecting (1) motion of the appliance and (2) if the appliance is in an operating orientation, wherein the optical motion sensor comprises:
a light source for illuminating a surface;
an optical sensor chip for capturing images of the surface and determining a surface quality value, the optical sensor chip comprising a register for storing the surface quality value, the surface quality value representing a number of visible features in an image captured by the optical sensor chip, the appliance being in the operating orientation, when the surface quality value is greater than a threshold;
a controller coupled to the optical motion sensor, wherein the controller turns off the appliance if the appliance is in the operating orientation and is not moving with sufficient velocity.

20. (canceled)
